(19) United States
(12) Patent Application Publication
(10) Pub. No.: US 2009/0157466 A1
(43) Pub. Date: Jun. 18, 2009

(54) APPARATUS, SYSTEM, AND METHOD FOR APPOINTMENT SCHEDULING

(75) Inventors: Judith H. Bank, Morrisville, NC (US); Lisa M. Bradley, Cary, NC (US); Lin Sun, Morrisville, NC (US); Chunhui Yang, Durham, NC (US)

Correspondence Address: Kunzler & McKenzie, 8 EAST BROADWAY, SUITE 600, SALT LAKE CITY, UT, 84111, US

(73) Assignee: International Business Machines Corporation, Armonk, NY (US)

(21) Appl. No.: 11/957,173

(22) Filed: Dec. 14, 2007

(51) Int. Cl. G06Q 10/00

(52) U.S. Cl. 705/9

(57) ABSTRACT

An apparatus, system, and method are disclosed for scheduling appointments. Appointment requests are received via a communication service, calendar information corresponding to the proposed appointment time and day is retrieved from a calendaring system and displayed to the user without requiring the user to open the calendaring application. The appointment can be accepted, confirmed, and recorded without opening the calendaring application. Multiple appointment times and days can be proposed and accepted among several meeting attendees. Temporary blocks may be placed on proposed and accepted calendar time slots until a finalized appointment time is negotiated and accepted.

### BACKGROUND OF THE INVENTION

1. Field of the Invention

This invention relates to appointment scheduling and more particularly relates to scheduling appointments utilizing an electronic calendaring system via a communication service.

2. Description of the Related Art

One of the most common software applications, familiar to computer users, is the electronic calendar system. Most calendaring systems include features for scheduling appointments between two or more users. Typically, a user who wants to schedule a meeting or appointment opens the calendaring program; creates an appointment message; sets a date, time, and location; and sends the appointment to one or more users to be accepted or declined. The greater the number of attendees to be included in a meeting or appointment, the more likely it is that the first proposed appointment time will not be acceptable to all attendees.

While computer users frequently make use of electronic calendar systems to manage their appointments and meetings, they typically use other software to communicate. Calendaring systems typically transmit appointments as a specialized type of email message, but the user interface dialogs for displaying calendaring information are typically separate from the email display. Furthermore, informal communication often takes place via instant messaging or the like. In the course of such informal communication, appointments or meetings may be proposed and accepted. In such cases, users typically have to open a window or other graphic interface for their calendaring system to verify whether a proposed appointment time is free. While this may seem like a minor annoyance, for many users it is one that occurs several times a day.

The situation is further complicated by the introduction of mobile computing devices. Many smart phones or other mobile devices support calendaring systems. Many of these devices also support email or instant messaging, along with other communication media such as SMS, MMS, and EMS messaging. On these devices, it is typically very inconvenient to switch from an email, text message, or instant messaging program to consult a calendaring program.

### SUMMARY OF THE INVENTION

The present invention has been developed in response to the present state of the art, and in particular, in response to the problems and needs in the art that have not yet been fully solved by currently available appointment scheduling systems. Accordingly, the present invention has been developed to provide an apparatus, system, and method for appointment scheduling that overcome many or all of the above-discussed shortcomings in the art.

The apparatus to schedule appointments is provided with a plurality of modules configured to functionally execute the necessary steps of appointment scheduling. These modules in the described embodiments may include a communication module that receives appointment requests, an appointment detection module that detects appointment requests transmitted via the communication service, and a calendar data retrieval module that retrieves calendar data from the calendaring system. The apparatus may also include a calendar data display module that immediately displays the calendar data, an appointment acceptance module that receives input from the user accepting or declining the appointment, and an appointment confirmation module that transmits appointment confirmations to the originating user. In one embodiment, the calendar data display module displays the calendar information in response to an indication that calendar information corresponding to each proposed appointment time and day is to be displayed. The indication may be a user configured setting, a user action, or the like.

In certain embodiments, the apparatus also includes an appointment request module that initiates the scheduling of an appointment, an appointment sending module that sends the appointment via the communication service, and an appointment confirmation parsing module that parses accepted appointment times and days. In one embodiment, the appointment request comprises at least one proposed appointment time and day embedded in a freeform text message. The apparatus may also include an appointment recording module that records accepted appointment times and days in the calendaring system, and an appointment finalization module that sends the finalized appointment to recipients of the proposed appointment.

The apparatus, in one embodiment, is configured to place temporary blocks on calendar time slots to prevent other appointments from being scheduled at those times until a finalized appointment time has been negotiated. In a further embodiment, the apparatus may be configured to aggregate appointment confirmations from several users. The apparatus, in one embodiment, is configured to display calendar data in several formats, as configured by the user.

A system of the present invention is also presented to schedule appointments. The system may include as a communication service such as email, instant messaging, text messaging, or the like; a calendaring system, and an appointment scheduler.

A method of the present invention is also presented for scheduling appointments. The method in the disclosed embodiments substantially includes the steps necessary to carry out the functions presented above with respect to the operation of the described apparatus and system. In one embodiment, the method includes receiving an appointment request via a communication service, detecting appointment times and days in the appointment request, retrieving calendar information in the appointment request, and displaying the calendar information to the user. The method may further include sending an appointment confirmation to the originating user, receiving the confirmation, parsing the appointment confirmation, and recording accepted appointment times and days. The method also may include sending, receiving, and recording the finalized appointment.

In a further embodiment, the method includes placing temporary blocks on calendar time slots corresponding to proposed appointment times until a finalized appointment time is negotiated and accepted. The method may also include aggregating a number of appointment confirmations, and delimiting the appointment request with identifying tags.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an appointment scheduling system in accordance with the present invention;

FIG. 2 is a schematic block diagram illustrating one embodiment of an appointment scheduler apparatus in accordance with the present invention;

FIG. 2a is a schematic block diagram illustrating one embodiment of an appointment creation module in accordance with the present invention;

FIG. 2b is a schematic block diagram illustrating one embodiment of an appointment completion module in accordance with the present invention;

FIG. 3 is a schematic block diagram illustrating one embodiment of an appointment receiving module in accordance with the present invention;

FIG. 4 is a schematic block diagram illustrating one embodiment of a calendaring module in accordance with the present invention;

FIG. 5 is a schematic block diagram illustrating one embodiment of an appointment reply module in accordance with the present invention;

FIG. 6 is a schematic flow chart diagram illustrating one embodiment of a method for appointment initiation in accordance with the present invention;

FIG. 7 is a schematic flow chart diagram illustrating one embodiment of a method for appointment receiving in accordance with the present invention;

FIG. 8 is a schematic flow chart diagram illustrating one embodiment of a method for calendar data display in accordance with the present invention;

FIG. 9 is a schematic flow chart diagram illustrating one embodiment of a method for appointment acceptance in accordance with the present invention;

FIG. 10 is a schematic flow chart diagram illustrating one embodiment of a method for appointment recording in accordance with the present invention; and

FIG. 11 is a schematic flow chart diagram illustrating one embodiment of a method for appointment finalization in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of causing execution of a program of machine-readable instructions on a digital processing apparatus. A computer readable medium may be embodied by a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

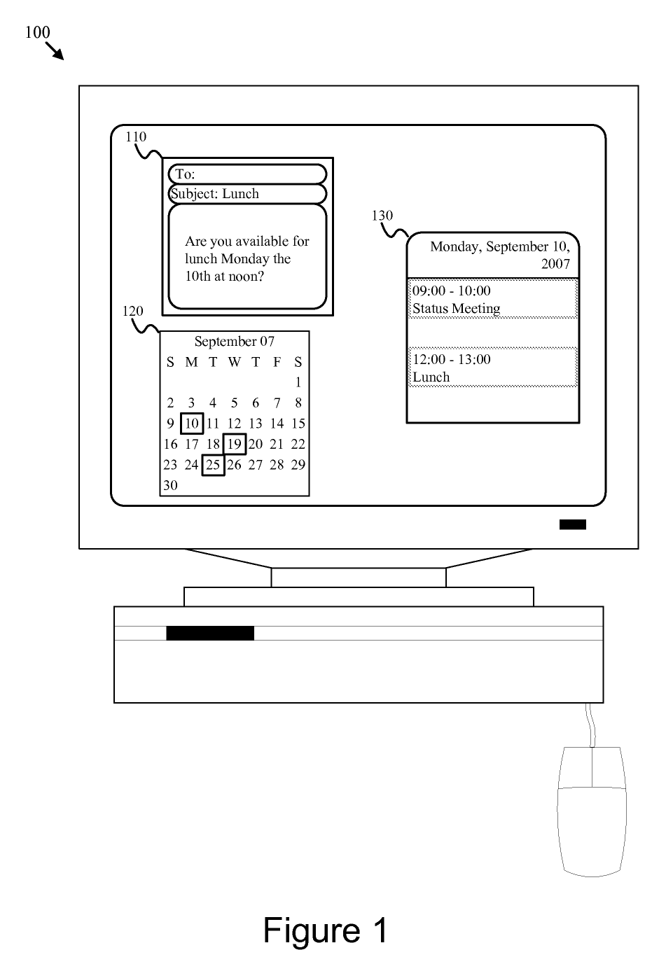

FIG. 1 depicts one embodiment of an appointment scheduling system 100 in accordance with the present invention. As depicted, the appointment scheduling system 100 includes a communication service 110, a calendaring system 120, and an appointment scheduler 130. The appointment scheduling system 100 facilitates scheduling an appointment via a communications service 110 without opening a calendaring system 120. Embodiments of the system provide means to allow the user to see calendar data for the particular time slots directly from messages communicated via the communication service 110 such as email, instant messages, or the like, containing references to the time slots. In this way, the appointment scheduling system 100 facilitates scheduling appointments without opening the calendaring system 120 and locating the corresponding entries. In one embodiment, a single sign-on facility or federated identity facility is used to facilitate inter-application communication between the calendaring system 120 and the communication service 110.

The communication service 110 communicates a message including a proposed appointment. The communication service 110 may be any one of a number of message-oriented communication media, including email, instant messaging (“chat” messages), short message service messages, enhanced message service messages, and multimedia message service messages. The user may include more than one proposed appointment time in a message.

The calendaring system 120 records proposed, confirmed and finalized appointment times and days. The calendaring system 120 may utilize a communication service other than the communication service 110 to schedule appointments with other users of the calendaring system 120. For example, the calendaring system 120 may use specially-formatted email messages to schedule appointments with other calendaring system 120 users, while the appointment scheduling system 100 uses instant messaging as the communication service 110.

The appointment scheduler 130 scans messages transmitted via the communication service 110 for proposed appointment times and days. In response to receiving proposed appointment times and days, the appointment scheduler 130 retrieves calendar data for the proposed time and day from the calendaring system 120. In one embodiment, the appointment scheduler 130 may be configured to display previously scheduled appointments from various time periods, such as one hour before and after a proposed time and day, or scheduled appointments for the entire day of a proposed time and day.

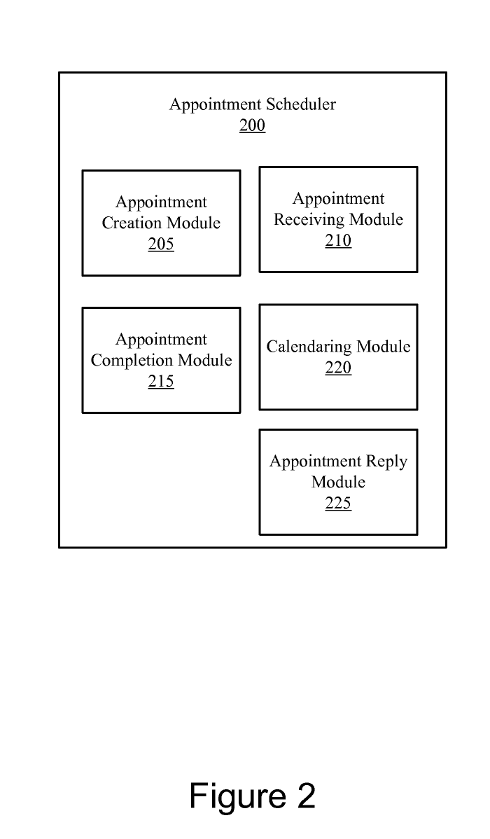

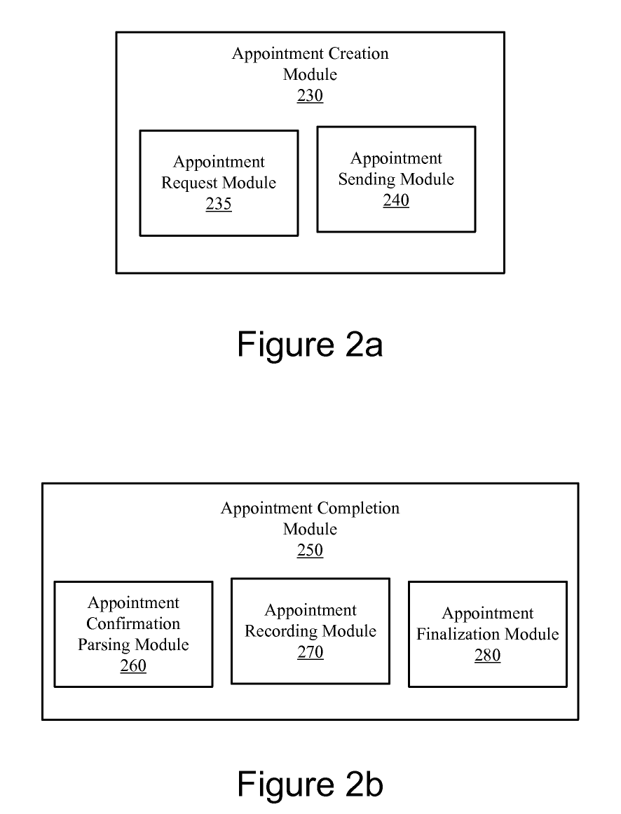

FIG. 2 depicts one embodiment of an appointment scheduler apparatus 200 in accordance with the present invention. As depicted, the appointment scheduler apparatus 200 includes an appointment creation module 205, an appointment receiving module 210, an appointment completion module 215, a calendaring module 220, and an appointment reply module 225. The appointment scheduler apparatus 200 facilitates scheduling an appointment via a communications service without opening a calendaring program.

The appointment creation module 205 creates an appointment to be transmitted in a message on the communication service 110. In one embodiment, the appointment creation module 205 places delimiting tags around a proposed time and day so that the proposed appointment will be recognized as a proposed appointment time and day when received by another user's appointment scheduler 200. In one embodiment, the appointment creation module 205 places delimiting tags around a confirmed time and day so that the confirmed appointment will be recognized as a confirmed appointment time and day when received by the initiating user's appointment scheduler 200.

The appointment receiving module 210 receives an appointment from the appointment creation module 205 via the communication service 110. The appointment receiving module 210 detects whether messages received via the communication service 110 contain proposed appointments.

The appointment completion module 215 receives appointment confirmations from one or more users that may be sent by the appointment reply module 225 via the communication service 110. In one embodiment, when an appointment is finalized, temporary blocks on proposed or confirmed times and days other than the finalized time and day may be removed and the blocks of time once again made available for scheduling.

The calendaring module 220 records the proposed appointment times and days in the calendaring system 120 of the user initiating the appointment. The calendaring module 220 also records the confirmed appointment in the calendaring system 120 of the user receiving the proposed appointment. In one embodiment, the recorded proposed and confirmed appointments act as temporary blocks on the proposed or confirmed times and days, so that other appointments are not scheduled during a proposed or confirmed time and day until the appointment has been finalized. At that time, temporary blocks on proposed or confirmed times and days other than the finalized time and day may be removed and the blocks of time once again made available for scheduling.

The appointment reply module 225 accepts one or more proposed appointment times and records them in the calendaring system 120. The appointment reply module 225 constructs an appointment confirmation with the accepted times to be sent to the initiating user via the communication service 110.

FIG. 2a depicts one embodiment of an appointment creation module 230 in accordance with the present invention. As shown, the appointment creation module 230 is one embodiment of the appointment creation module 205 depicted in FIG. 2. The appointment creation module 230 includes an appointment request module 235, and an appointment sending module 240. The appointment creation module 230 facilitates creation of proposed or confirmed appointments to be communicated via a communications service.

The appointment request module 235 creates proposed appointments to be transmitted in messages sent via the communication service 110. In one embodiment, the appointment request module 235 places delimiting tags around a proposed time and day so that the proposed appointment will be recognized as a proposed appointment time and day when received by another user's appointment scheduler 200. In one embodiment, a proposed appointment may contain a plurality of proposed times and days delimited by identifying tags. Proposed times and days may be delimited by different tags than the tags used to identify the proposed appointment that comprises them. In one embodiment, the appointment includes an expiration time by which time the appointment must be finalized or temporary blocks on proposed time slots will be removed, so that the time slots are once again made available for scheduling. In other embodiments, proposed appointments may also be transmitted in freeform text without delimiting tags.

The appointment sending module 240 transmits the message containing the proposed appointment from the user initiating the appointment to one or more users via the communication service 110. In one embodiment, the appointment sending module 240 also transmits the finalized appointment from the initiating user to the appointment scheduler 200 of each recipient user.

FIG. 2b depicts one embodiment of an appointment completion module 250 in accordance with the present invention. As shown, the appointment completion module 250 includes an appointment confirmation parsing module 260, an appointment recording module 270, and an appointment finalization module 280. The appointment completion module 250 facilitates receiving appointment confirmations and finalizing the appointment.

The confirmation parsing module 260 parses an appointment confirmation to identify each confirmed time and day included in the appointment confirmation. In one embodiment, the confirmation parsing module 260 parses appointment confirmations with or without delimiting tags.

The appointment recording module 270 records accepted appointment times and dates in the calendaring system 120. In one embodiment, the appointment recording module 270 aggregates appointment confirmations from more than one user who received messages with proposed appointment times and dates.

The appointment finalization module 280 schedules the final appointment time and day in the calendaring system 120. In one embodiment, the appointment finalization module 280 removes temporary blocks on proposed appointment times and days other than the appointment time and day, so that those blocks of time are once again available for scheduling. In one embodiment, the appointment finalization module 280 selects the finalized appointment time and day based on which time slot was accepted by the greatest number of users. In one embodiment, the appointment finalization module 280 selects the finalized appointment time and day based on a selection made by the user initiating the appointment. In one embodiment, the appointment finalization module 280 directs the calendaring system 120 to notify other users of the calendaring system 120 of the finalized appointment.

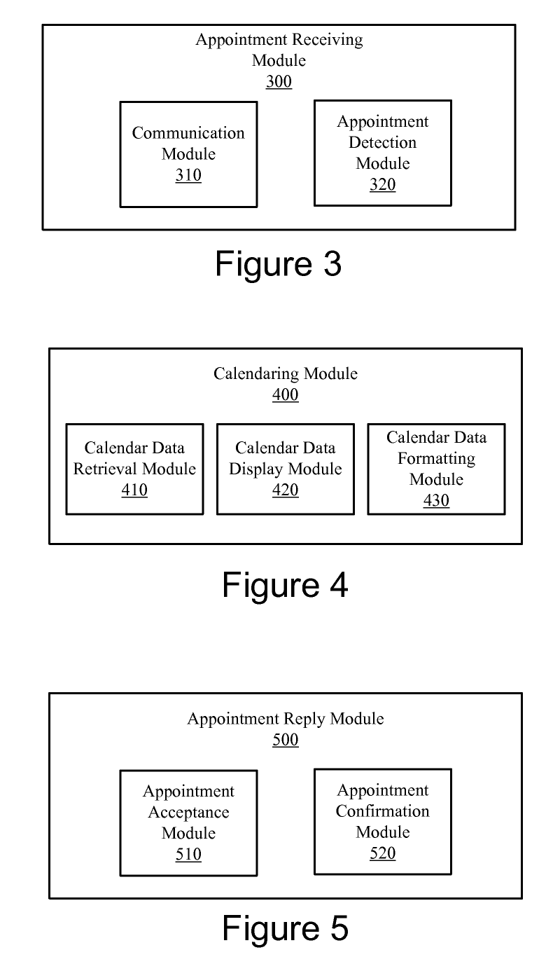

FIG. 3 depicts one embodiment of an appointment receiving module 300 in accordance with the present invention. As shown, the appointment receiving module 300 is one embodiment of the appointment receiving module 210 depicted in FIG. 2. The appointment receiving module 300 includes a communication module 310, and an appointment detection module 320. The appointment receiving module 300 facilitates receiving and identifying appointments sent by the appointment creation module 205 via the communication service 110.

The communication module 310 receives the proposed appointment from the appointment sending module 240 of the appointment creation module 230 of the initiating user. In one embodiment, the communication module 310 also receives the finalized appointment from the appointment sending module 240 of the appointment creation module 230 of the initiating user.

The appointment detection module 320 scans messages received via the communication service 110 for appointments. In one embodiment, the appointment detection module 320 detects both proposed appointments and confirmed appointments. In one embodiment, the appointment detection module 320 detects appointments with or without delimiting tags. By detecting proposed appointments without delimiting tags, the appointment detection module 320 provides the capability of the present invention to display calendar data to the user even when a message is received via the communication service 110 from a user who does not have the appointment scheduler 130 installed.

FIG. 4 illustrates one embodiment of a calendaring module 400 in accordance with the present invention. As depicted, the calendaring module 400 is one embodiment of the calendaring module 220 depicted in FIG. 2. The calendaring module 400 includes a calendar data retrieval module 410, a calendar data display module 420, and a calendar data formatting module 430. The calendaring module 400 facilitates communication between users, the appointment scheduler 130, and the calendaring system 120.

The calendar data retrieval module 410 acquires data associated with a proposed appointment time and day or a confirmed appointment time and day from the calendaring system 120. In one embodiment, the calendar data retrieval module 410 can be configured by the user to acquire data within a specified period of time from the appointment. For example, the user may specify that the calendar data retrieval module 410 should acquire calendar data within one hour of the appointment, or the same day as the appointment.

The calendar data display module 420 displays data acquired from the calendaring system 120 associated with a proposed appointment time and day or a confirmed appointment time and day, formatted by the calendar data formatting module 430. In one embodiment, the calendar data display module 420 provides the user with an option to display calendar data when a message containing a proposed appointment time and day is received or opened. The calendar data display module 420 may also display calendar data in response to an event such as the user moving a cursor over a proposed appointment time and day, the user activating an interface control, or the like.

In one embodiment, the calendar data display module 420 provides the user with options to retrieve detailed information about a particular calendar entry, edit existing appointments in the calendaring system, or open the calendaring system to obtain a more complete view of the user's schedule. In one embodiment, the calendar data display module 420 displays a user interface control that allows the user to select the content and format of the calendar data to be formatted by the calendar data formatting module 430 and displayed by the calendar data display module 420.

The calendar data formatting module 430 configures the content and format of calendar data displayed by the calendar data display module 420. In one embodiment, the calendar data formatting module 430 can be configured by the user to display data within a specified period of time from the appointment. For example, the user may specify that the calendar data display module 420 should display calendar data within one hour of the appointment, or the same day as the appointment.

FIG. 5 illustrates one embodiment of an appointment reply module 500 in accordance with the present invention. As depicted, the appointment reply module 500 is one embodiment of the appointment reply module 225 depicted in FIG. 2. The appointment reply module 500 includes an appointment acceptance module 510, and an appointment confirmation module 520. The appointment reply module 500 facilitates accepting proposed appointments.

The appointment acceptance module 510 accepts a proposed appointment time and day and records the proposed appointment in the calendaring system 120. In one embodiment, the appointment acceptance module 510 accepts a plurality of appointment times and days as times and days that are acceptable to the user for the finalized appointment. In one embodiment, the appointment acceptance module 510 schedules the accepted appointment as a temporary block on the accepted time slot or time slots, so that other appointments are not scheduled during an accepted time and day until the appointment has been finalized. At that time, temporary blocks on accepted time slots other than the finalized appointment time and day may be removed and the blocks of time once again made available for scheduling. In one embodiment, the appointment acceptance module 510 sets an expiration time by which time the appointment must be finalized or temporary blocks on accepted time slots will be removed, so that the time slots are once again made available for scheduling.

The appointment confirmation module 520 creates confirmed appointments to be transmitted in messages sent via the communication service 110. In one embodiment, the appointment confirmation module 520 places delimiting tags around a confirmed time and day so that the confirmed appointment will be recognized as a confirmed appointment time and day when received by the initiating user's appointment scheduler 200. In one embodiment, a confirmed appointment may contain a plurality of confirmed times and days delimited by identifying tags. Confirmed times and days may be delimited by different tags than the tags used to identify the confirmed appointment that comprises them. In other embodiments, the appointment confirmation module 520 creates confirmed appointments without delimiting tags.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

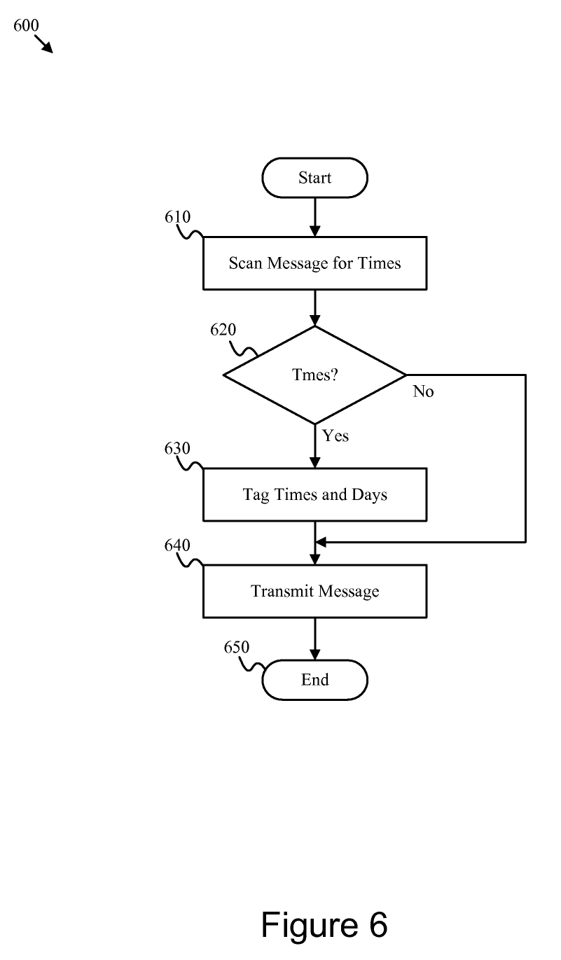

FIG. 6 depicts one embodiment of a method for appointment initiation 600 in accordance with the present invention. As shown, the appointment initiation method 600 includes a scan message for times operation 610, a times present test 620, a tag times and days operation 630, and a transmit message operation 640. The appointment initiation method 600 facilitates the proposing of an appointment time and day. The appointment may include more than two users and may include a plurality of proposed appointment times.

The scan message for times operation 610 scans a message to be transmitted via the communication service 110 for times and days for a proposed appointment. In various embodiments, the scan message for times operation 610 recognizes references to times and days in various formats, such as, “9/17 at 11:30,” “next Tuesday at noon,” or “tomorrow at 5 pm.”

The times present test 620 determines whether the message to be transmitted via the communication service 110 contains times and days for a proposed appointment. If the message contains times and days, the appointment initiation method 600 continues with the tag times and days operation 630, otherwise the appointment initiation method 600 continues with the transmit message operation 640.

The tag times and days operation 630 tags times and days in the message with delimiting tags. In one embodiment, the tag times and days operation 630 converts references to times and days to a standard format. For example, in a message containing a reference to “tomorrow at 3 pm,” the tag times and days operation 630 may embed a delimited string containing “10/3/07 15:00 MDT.”

The transmit message operation 640 transmits the message via the communication service 110. When the transmit message operation 640 is completed, the appointment initiation method 600 ends 650.

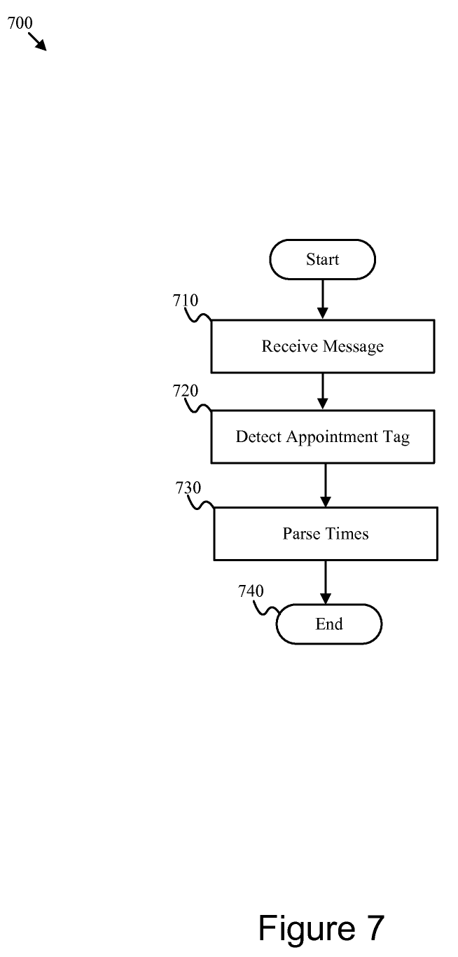

FIG. 7 depicts one embodiment of a method for appointment receiving 700 in accordance with the present invention. As depicted, the appointment receiving method 700 includes a receive message operation 710, a detect appointment tag operation 720, and a parse times operation 730. The appointment receiving method 700 facilitates receiving and identifying a proposed appointment via a communication service 110.

The receive message operation 710 receives a message sent via the communication service 110. In one embodiment, the receive message operation 710 intercepts the message before it is displayed to the user, so that the message can be displayed to the receiving user without delimiting tags or standardized time and day strings embedded in the message by the appointment initiation method 600.

The detect appointment tag operation 720 scans the message to detect whether the message contains tags embedded in the message by the appointment initiation method 600 delimiting a proposed appointment. In one embodiment, separate delimiting tags are used to identify a proposed appointment and for proposed times and days for the proposed appointment. Using separate tags in this manner facilitates negotiation of multiple appointment times between users. For example, a message may contain two proposed times for a meeting. Both blocks of time can be temporarily blocked on the receiving user's calendar until the finalized time and day for the meeting has been negotiated.

The parse times operation 730 parses times and days within the proposed appointment. In one embodiment, the parse times operation 730 also scans the message received via the communication service 110 for times and days without delimiting tags. By detecting proposed appointments without delimiting tags, the parse times operation 730 provides the capability of the present invention to display calendar data to the user even when a message is received via the communication service 110 from a user who does not have the appointment scheduler 130 installed.

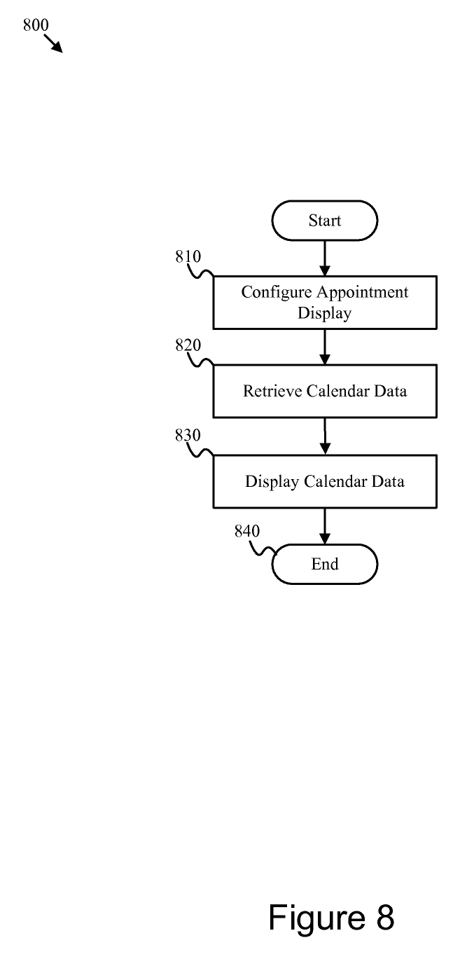

FIG. 8 illustrates one embodiment of a method for calendar data display 800 in accordance with the present invention. As depicted, the calendar data display method 800 includes a configure appointment display method 810, a retrieve calendar data operation 820, and a display calendar data operation 830. The calendar data display method 800 facilitates the user-configurable display of calendar data without opening the calendaring program.

The configure appointment display method 810 configures how calendar data is displayed to the user. In one embodiment, the user may specify whether, the calendar data display method 800 displays calendar data one hour before and after a proposed appointment time and day, a specified number of hours before and after a proposed appointment time and day, business hours of the proposed appointment day, or the entire 24-hour day of a proposed appointment day. In one embodiment, the calendar appointment display method 810 provides the user with an option to display calendar data when a message containing a proposed appointment time and day is received or opened.

The retrieve calendar data operation 820 retrieves calendar data corresponding to a proposed appointment time and day from the calendaring system 120. In various embodiments, the retrieve calendar data operation 820 is implemented to operate with products from various software manufacturers or standard calendaring and scheduling APIs such as the x/Open and XAPIA Calendaring and Scheduling API (CSA).

The display calendar data operation 830 displays calendar data retrieved from the calendaring system 120 to the user in the format specified by the configure appointment display operation 810. In one embodiment, the display calendar data operation 830 displays calendar data when a message containing a proposed appointment time and day is received or opened In another embodiment, calendar data is displayed in response to an event such as the user moving a cursor over a proposed appointment time and day, the user activating an interface control, or the like. In one embodiment, the calendar data is displayed in a pop-up window adjacent to the message display for the communication service 110.

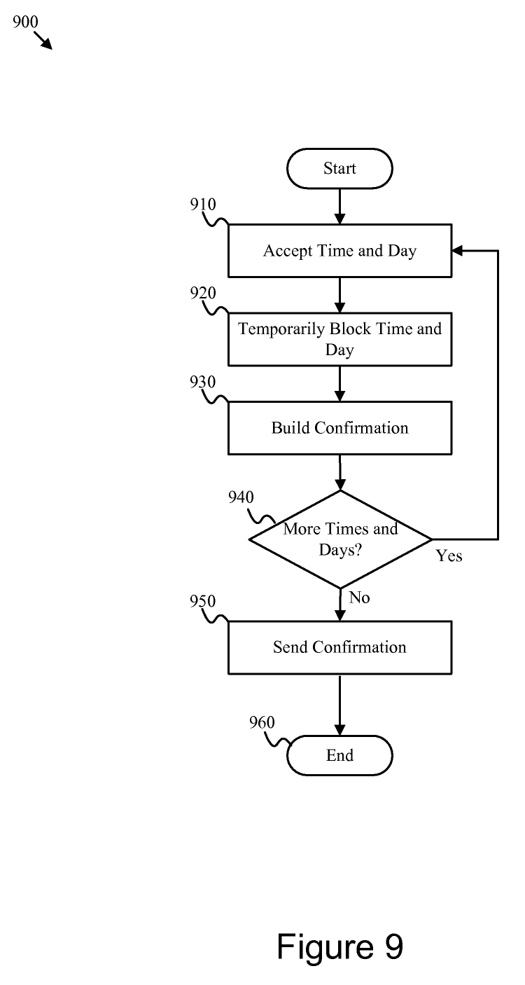

FIG. 9 depicts one embodiment of a method for appointment acceptance 900 in accordance with the present invention. As shown, the appointment acceptance method 900 includes an accept time and day operation 910, a temporarily block time and day operation 920, a build confirmation operation 930, a more times and days test 940, and a send confirmation operation 950. The appointment acceptance method 900 facilitates accepting and confirming a proposed appointment without opening the calendaring program.

The accept time and day operation 910 accepts a proposed appointment time and day, based on input from the user receiving the message containing the proposed appointment time and day. In one embodiment, the user clicks a button on a pop-up window, indicating the proposed appointment time and day is acceptable. In one embodiment, proposed appointments that conflict with existing appointments are automatically removed from the list of accepted appointments.

The temporarily block time and day operation 920 blocks an accepted appointment time and day in the users calendaring system 120. Blocking the accepted appointment time and day prevents other appointments from being scheduled during that block of time before the finalized appointment time and day is received. In one embodiment, more than one time and day may be blocked for one proposed appointment. Blocking multiple proposed appointment times facilitates negotiation of appointment times and days, particularly when the appointment involves more than two users.

The build confirmation operation 930 collects accepted times and days to be sent in an appointment confirmation message to the user who sent the proposed appointment. In one embodiment, an appointment confirmation may include more than one confirmed appointment times and days. In one embodiment, the confirmation is enclosed in a string marked with delimiting tags.

The more times and days test 940 determines whether more times and days have been accepted. In one embodiment, the more times and days test 940 is implemented as a “Done” button that the user clicks to indicate that there are no more times and days to be accepted. If there are more times and days to be accepted, the appointment acceptance method 900 continues with the accept time and day operation 910, otherwise the appointment acceptance method 900 continues with the send confirmation operation 950.

The send confirmation operation 950 sends the appointment confirmation in a message via the communication service 110 to the user who sent the proposed appointment. When the send confirmation operation 950 is completed, the appointment acceptance method 900 ends 960.

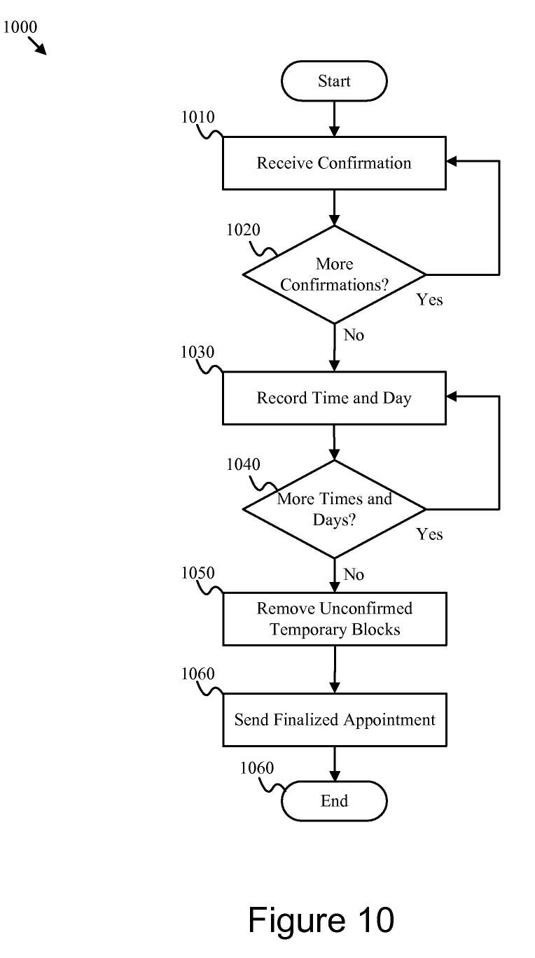

FIG. 10 illustrates one embodiment of a method for appointment recording 1000 in accordance with the present invention. As depicted, the appointment recording method 1000 includes a receive confirmation method 1010, a more confirmations test 1020, a record time and day operation 1030, a more times and days test 1040, a remove unconfirmed temporary blocks operation 1050, and a send finalized appointment operation 1060. The appointment recording method 1000 facilitates recording appointment confirmations. Appointment confirmations may be aggregated from a plurality of users. Each confirmation may include a plurality of confirmed appointment times and days.

The receive confirmation method 1010 receives a confirmed appointment in a message sent via the communication service 110. In one embodiment, the receive confirmation method 1010 scans the message for a delimiting tag identifying a string containing a confirmed appointment.

The more confirmations test 1020 determines whether more appointment confirmations associated with the proposed are to be received from other users. If more confirmations are to be received, the appointment recording method 1000 continues with the receive confirmations operation 1010, otherwise the appointment recording method 1000 continues with the record time and day operation 1030.

The record time and day operation 1030 records a time and day received in a confirmed appointment sent in a message via the communication service 110. In one embodiment, the record time and day operation parses the string within the delimiting tags identifying the confirmed appointment for one or more confirmed appointment times and days to be recorded. In one embodiment, the record time and day operation 1030 marks times and days that were previously temporarily blocked in the calendaring system 120 as confirmed appointments.

The more times and days test 1040 determines whether more confirmed times and days have been received. If there are more confirmed times and days, the appointment recording method 1000 continues with the record time and day operation 1030, otherwise the appointment recording method 1000 continues with the remove unconfirmed temporary blocks operation 1050.

The remove unconfirmed temporary blocks operation 1060 removes temporary blocks in the calendaring system 120 from times and days that were temporarily blocked as proposed appointment times and days. In one embodiment, Temporary blocks on appointment times and days not marked as confirmed are deleted, freeing those times and days to be scheduled for other appointments.

The send finalized appointment operation 1060 sends the finalized appointment to one or more recipients of the proposed appointment. In one embodiment, user is presented with confirmed appointments from which to choose the finalized appointment. In one embodiment, the finalized appointment is sent automatically when only one confirmed appointment exists. In one embodiment, the send finalized appointment operation 1060 directs the calendaring system 120 to send the finalized appointment as an appointment in its native format via its own separate communication service. When the send finalized appointment operation 1060 is completed, the appointment recording method 1000 ends 1060.

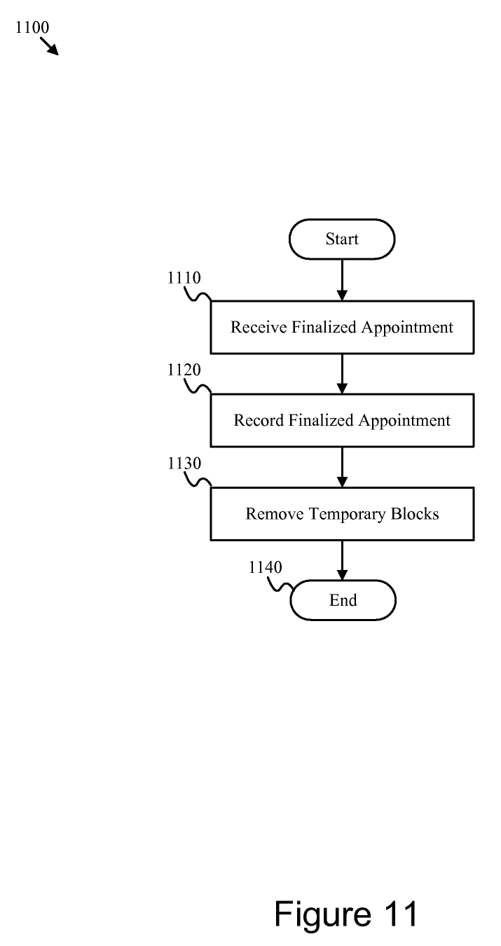

FIG. 11 depicts one embodiment of a method for appointment finalization 1100 in accordance with the present invention. As depicted, the appointment finalization method 1100 includes a receive finalized appointment operation 1110, a record finalized appointment 1120, and a remove temporary blocks operation 1130. The appointment finalization method 1100 facilitates finalizing an appointment after an appointment confirmation has been received.

The receive finalized appointment operation 1110 receives the finalized appointment sent in the appointment recording method 1000. In one embodiment, the receive finalized appointment operation 1110 received the finalized appointment as an appointment made through the calendaring system 120.

The record finalized appointment 1120 records the finalized appointment in the calendaring system 120. In one embodiment, the appointment is recorded by the calendaring system 120 and the record finalized appointment 1120 only recognizes that the finalized appointment has been recorded.

The remove temporary blocks operation 1130 removes temporary blocks from confirmed appointment times and days other than the finalized appointment time and day. The temporarily blocked times and days are then available to be scheduled for other appointments. When the remove temporary blocks operation 1130 is completed, the appointment finalization method ends 1140.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for scheduling appointments, the method comprising:
receiving an appointment request via a communication service, the appointment request comprising at least one proposed appointment time and day embedded in a freeform text message, the communication service selected from the group consisting of email, instant messaging, short message service messages, enhanced message service messages, and multimedia message service messages;
parsing the freeform text message to detect each proposed appointment time and day in the appointment request;
retrieving calendar information corresponding to each proposed appointment time and day;
displaying the calendar information in response to an indication that calendar information corresponding to each proposed appointment time and day is to be displayed; and
sending an appointment confirmation in response to a user acceptance of at least one proposed appointment time and day.

2. The method of claim 1, further comprising
receiving a finalized appointment time and day; and
recording the finalized appointment time and day.

3. The method of claim 2, wherein
sending an appointment confirmation further comprises placing a temporary block on calendar time slots corresponding to each accepted appointment time and day; and
recording the finalized appointment time and day further comprises removing at least one temporary block on a calendar time slot corresponding to proposed appointment times and days other than the finalized appointment time and day.

4. The method of claim 1, further comprising configuring one or more of the format and the content of calendar information displayed in response to user input, the format and the content of calendar information displayed comprising calendar information corresponding with time periods selected from the group comprising a proposed appointment time and day, time periods adjacent to a proposed appointment time and day, a configurable number of hours adjacent to a proposed appointment time and day, the day of a proposed appointment time and day, and the week of a proposed appointment time and day.

5. The method of claim 1, wherein the indication that calendar information corresponding to each proposed appointment time and day is to be displayed comprises indications selected from the group consisting of a mouseover event indication, an option setting indication, and an interface control activation indication.

6. A method for scheduling appointments, the method comprising:
initiating an appointment request via a communication service, the appointment request comprising at least one proposed appointment time and day embedded in a freeform text message, the communication service selected from the group consisting of email, instant messaging, short message service messages, enhanced message service messages, and multimedia message service messages;
receiving an appointment confirmation comprising at least one accepted time and day;
parsing the appointment confirmation to identify each accepted appointment time and day within the appointment confirmation;
selecting a finalized appointment time and day; and
sending a finalized appointment time and day.

7. The method of claim 6, wherein:
initiating the appointment request further comprises placing a temporary block on calendar time slots corresponding to each proposed appointment time and day; and
selecting a finalized appointment time and day further comprises removing at least one temporary block on a calendar time slot corresponding to a calendar time slot other than the accepted times and days.

8. The method of claim 6, further comprising aggregating a plurality of appointment confirmations from a plurality of users.

9. The method of claim 6, wherein initiating the appointment request further comprises delimiting the appointment request with identifying markers, delimiting the appointment request with identifying markers further comprising delimiting each proposed time and day with identifying markers.

10. An apparatus to schedule appointments, the apparatus comprising:
a communication module configured to receive an appointment request, the appointment request comprising at least one proposed appointment time and day embedded in a freeform text message,
an appointment detection module configured to parse the freeform text message to detect the appointment request, the appointment detection module further configured to identify each proposed appointment time and day within the appointment request;
a calendar data retrieval module configured to retrieve calendar data corresponding to each proposed appointment time and day;
a calendar data display module configured to receive an indication that calendar information corresponding to each proposed appointment time and day is to be displayed, the calendar data display module further configured to display calendar data corresponding to a proposed appointment time and day;
an appointment acceptance module configured to accept at least one appointment time and day; and
an appointment confirmation module configured to transmit an appointment confirmation, the appointment confirmation comprising at least one appointment time and day.

11. The apparatus of claim 10, wherein receiving an indication that calendar information corresponding to each proposed appointment time and day is to be displayed comprises indications selected from the group consisting of a mouseover event indication, an option setting indication, and an interface control activation indication

12. The apparatus of claim 10, further comprising
an appointment request module configured to initiate an appointment request, the appointment request comprising at least one proposed appointment time and day;
an appointment sending module configured to transmit the appointment request;
an appointment confirmation parsing module configured to parse each accepted appointment time and day within an appointment confirmation;
an appointment recording module configured to record each accepted appointment time and day; and
an appointment finalization module configured to send a finalized appointment time and day and record the finalized appointment.

13. The apparatus of claim 12, wherein
the appointment request module is further configured to place a temporary block on calendar time slots corresponding to each proposed appointment time and day;
the appointment acceptance module is further configured to place a temporary block on the calendar time slot corresponding to the accepted appointment time and day;
the appointment recording module is further configured to remove a temporary block on at least one calendar time slot corresponding to an accepted appointment time and day; and
the appointment finalization module is further configured to remove a temporary block on at least one calendar time slot corresponding to the finalized appointment time and day.

14. The apparatus of claim 11, wherein the appointment recording module is further configured to aggregate a plurality of appointment confirmations from a plurality of users.

15. The apparatus of claim 11, further comprising a calendar data formatting module configured to configure one or more of the format and the content of calendar information displayed in response to user input, the format and the content of calendar information displayed comprising calendar information corresponding with time periods selected from the group comprising a proposed appointment time and day, time periods adjacent to a proposed appointment time and day, a configurable number of hours adjacent to a proposed appointment time and day, the day of a proposed appointment time and day, and the week of a proposed appointment time and day.

16. A system to schedule appointments, the system comprising:
a communication service selected from the group consisting of email, instant messaging, short message service messages, enhanced message service messages, and multimedia message service messages;
a calendaring system configured to record an appointment, the appointment comprising an appointment time and day, the calendaring system further configured to transmit an appointment via a network; and
a plurality of appointment schedulers configured to initiate an appointment request having an embedded freeform text message via the communication service, the appointment request comprising at least one proposed appointment time and day, the appointment schedulers further configured to receive an appointment request, parse the embedded freeform text message to detect each proposed appointment time and day in the appointment request, retrieve calendar information associated with each proposed appointment time and day from the calendaring system, receive an indication that calendar information corresponding to each proposed appointment time and day is to be displayed, display the calendar information, accept at least one proposed appointment time and day, and send at least one appointment confirmation corresponding to the accepted appointment time and day via the communication service.

17. The system of claim 16, wherein the appointment schedulers are further configured to direct the calendaring system to schedule an appointment, the appointment schedulers further configured to direct the calendaring system to cancel an appointment.

18. A computer program product comprising a computer readable medium having computer usable program code executable to perform operations for scheduling appointments, the operations of the computer program product comprising:
receiving an appointment request via a communication service, the appointment request comprising at least one proposed appointment time and day embedded in a freeform text message, the communication service selected from the group consisting of email, instant messaging, short message service messages, enhanced message service messages, and multimedia message service messages;
parsing the freeform text message to detect each proposed appointment time and day in the appointment request;
retrieving calendar information corresponding to each proposed appointment time and day;
displaying the calendar information corresponding to each proposed appointment time and day, in response to an indication that calendar information corresponding to each proposed appointment time and day is to be displayed; and
sending an appointment confirmation in response to a user acceptance of at least one proposed appointment time and day.

19. The computer program product of claim 18, further comprising
receiving the finalized appointment time and day; and
recording the finalized appointment.

20. The computer program product of claim 19, wherein
sending an appointment confirmation further comprises placing a temporary block on calendar time slots corresponding to each accepted appointment time and day; and
recording the finalized appointment time and day further comprises removing at least one temporary block on a calendar time slot corresponding to proposed appointment times and days other than the finalized appointment time and day.

21. The computer program product of claim 18, wherein the indication that calendar information corresponding to each proposed appointment time and day is to be displayed comprises indications selected from the group consisting of a mouseover event indication, an option setting indication, and an interface control activation indication

22. The computer program product of claim 18, further comprising:
initiating the appointment request via a communication service, the appointment request comprising at least one proposed appointment time and day embedded in a freeform text message, the communication service selected from the group consisting of email, instant messaging, short message service messages, enhanced message service messages, and multimedia message service messages;
receiving an appointment confirmation comprising at least one accepted time and day;
parsing the appointment confirmation to identify each accepted appointment time and day within the appointment confirmation;
selecting a finalized appointment time and day; and
sending a finalized appointment time and day.

23. The computer program product of claim 18, wherein
initiating the appointment request further comprises placing a temporary block on calendar time slots corresponding to each proposed appointment time and day embedded in a freeform text message; and
selecting a finalized appointment time and day further comprises removing at least one temporary block on a calendar time slot corresponding to a calendar time slot other than the accepted times and days.
